(19) United States
(12) Patent Application Publication
(10) Pub. No.: US 2016/0147305 A1
(43) Pub. Date: May 26, 2016

(54) DISPLAY DEVICE

(71) Applicant: Samsung Display Co., Ltd., Yongin-City (KR)

(72) Inventor: Won-Ki HONG, Suwon-si (KR)

(21) Appl. No.: 14/675,084

(22) Filed: Mar. 31, 2015

(30) Foreign Application Priority Data
Nov. 21, 2014 (KR) 10-2014-0163312

(51) Int. Cl. G06F 3/01; G06F 3/042

(52) U.S. Cl. CPC G06F 3/016; G06F 3/042

(57) ABSTRACT

A display device includes a lower substrate, an upper substrate facing the lower substrate, an electro-optical active layer disposed between the lower substrate and the upper substrate, and a plurality of membranes arranged on a surface of one of the lower substrate and the upper substrate. The plurality of membranes are configured to absorb light of a specific wavelength and vibrate so as to generate ultrasonic waves.

### CROSS-REFERENCE TO RELATED APPLICATION

This application claims priority to and the benefit of Korean Patent Application No. 10-2014-0163312 filed in the Korean Intellectual Property Office on Nov. 21, 2014, the entire contents of which are incorporated herein by reference.

### BACKGROUND

(a) Technical Field

The present disclosure generally relates to a display device and more particularly, to a display device including a haptic function.

(b) Description of the Related Art

Flat panel displays (FPD), such as organic light emitting diode displays (OLEDs) and liquid crystal display (LCDs), typically include a display panel including a field generating electrode and an electro-optical active layer. The electro-optical active layer may be based on different light emission materials. For example, the display panel of the organic light emitting device may include an organic emission layer as the electro-optical active layer, and the display panel of the liquid crystal display may include a liquid crystal layer as the electro-optical active layer. The field generating electrode is connected to a switching element (such as a thin film transistor) to receive a data signal, and the electro-optical active layer converts the data signal to an optical signal to display an image.

To improve user interface of the display device, a haptic technique for allowing a user to interact with the display device through sense of touch has been researched. For example, haptic feedback is useful when the user touches, grabs, or moves an object in a 3-dimensional (3D) space. Haptic feedback is also used to reinforce the user experience with the display device through the user interface (for example, when actions such as a gesture or a hovering motion are performed in the user interface). In particular, haptic feedback can be used to allow a user to interact with a virtual object in the 3D space.

To provide a haptic effect/feedback, a haptic actuator such as a vibration element may be used, and a space for holding the haptic actuator may be provided in the display device. The haptic actuator may operate based on a piezoelectric effect or an electrostatic method. The haptic actuator typically includes an electrode. However, the electrode of the haptic actuator is usually opaque and disposed at a bottom side of the display device, and includes a plurality of wires which may increase the volume of the display device. As a result, packaging challenges in integrating the haptic actuator with the display device may arise.

The above information disclosed in this Background section is only to enhance understanding of the background of the inventive concept and may contain information that does not constitute prior art that is already known in this country to a person of ordinary skill in the art.

### SUMMARY

The present disclosure provides a display device having a haptic function.

According to an embodiment of the inventive concept, a display device is provided. The display device includes: a lower substrate; an upper substrate facing the lower substrate; an electro-optical active layer disposed between the lower substrate and the upper substrate; and a plurality of membranes arranged on a surface of one of the lower substrate and the upper substrate, wherein the plurality of membranes are configured to absorb light of a specific wavelength and vibrate so as to generate ultrasonic waves.

In some embodiments, the display device may further include at least one light source for irradiating the light of the specific wavelength.

In some embodiments, the plurality of membranes may be disposed between the upper substrate and the electro-optical active layer.

In some embodiments, the display device may further include a polarizer film disposed on the upper substrate, wherein the plurality of membranes may be disposed between the upper substrate and the polarizer film.

In some embodiments, the plurality of membranes may be disposed outside the lower substrate.

In some embodiments, the display panel may further include a polarizer film disposed on the upper substrate and a window disposed on the polarizer film, wherein the plurality of membranes may be disposed between the polarizer film and the window.

In some embodiments, the light source may be disposed in the electro-optical active layer.

In some embodiments, the light source may be disposed in a non-emitting region of the electro-optical active layer.

In some embodiments, the light source may be disposed in a pixel area of the electro-optical active layer.

In some embodiments, the light source may be disposed under the lower substrate.

In some embodiments, the light source may be an infrared organic light emitting diode.

In some embodiments, the light source may be an infrared light emitting diode.

In some embodiments, the light of the specific wavelength may include light in a near infrared ray region, wherein the plurality of membranes may vibrate upon absorbing the light in the near infrared ray region, and wherein the plurality of membranes may be transparent to light in a visible region.

In some embodiments, the display device may further include a touch sensor configured to generate a signal for sensing a user's touch.

In some embodiments, the touch sensor may include a motion sensor for sensing a spatial touch.

In some embodiments, the display device may further include: a touch controller configured to apply a driving voltage to the touch sensor and generate an output signal based on touch information; a haptic controller configured to apply a driving voltage to the haptic actuator; and a signal controller configured to apply a touch control signal to the touch controller, and apply a haptic control signal to the haptic controller based on an output signal of the touch controller.

According to some or all of the above-described embodiments, haptic efficiency of a display device may be improved by including a plurality of membranes for generating ultrasonic waves which provide haptic effect(s). Also, the plurality of membranes are transparent to visible light and therefore do not impact the optical efficiency of the display device. In addition, the plurality of membranes are not electrically/mechanically driven since the membranes vibrate on their own under light absorption. In particular, the plurality of membranes need not be connected to electrical wiring, which simplifies the layout/configuration of the haptic actuator and allows the haptic actuator to be easily integrated into the display device. Furthermore, different haptic effects may be provided by varying the vibration (e.g., amplitude and/or frequency) of the plurality of membranes, such that fast response speeds ranging from several nanoseconds to several microseconds may be realized.

### BRIEF DESCRIPTION OF THE DRAWINGS

FIG. 1 illustrates a display device according to an exemplary embodiment.

FIG. 2 illustrates a cross-sectional view of the display device of FIG. 1 taken along line A-A.

FIG. 3 illustrates a portion of a haptic actuator in a display device according to an exemplary embodiment.

FIG. 4 is a flowchart of a method of operating a haptic actuator according to an exemplary embodiment.

FIGS. 5, 6, 7, 8, and 9 illustrate cross-sectional views of a display device according to different exemplary embodiments in which a membrane and a light source of a haptic actuator are disposed in different locations.

FIGS. 10, 11, and 12 illustrate a haptic feedback process in a display device according to an exemplary embodiment.

FIG. 13 illustrates a timing diagram of a touch input and a haptic feedback according to an exemplary embodiment.

FIG. 14 is a flowchart of a haptic driving algorithm according to an exemplary embodiment.

FIG. 15 illustrates a block diagram of a display device according to an exemplary embodiment.

### DETAILED DESCRIPTION

In the following description, exemplary embodiments are shown and described by way of illustration. As one of ordinary skill in the art would realize, the embodiments may be modified in various ways without departing from the spirit or scope of the present disclosure.

In the drawings, the thicknesses of layers, films, panels, regions, etc., may be exaggerated for clarity. It will be understood that when an element such as a layer, film, region, or substrate is referred to as being “on” another element, it can be directly on the other element or with one or more intervening elements being present. In contrast, when an element is referred to as being “directly on” another element, there are no intervening elements present.

The following embodiments are primarily described with reference to an organic light emitting device. However, the inventive concept is not limited thereto, and may be applied to other types of display devices such as liquid crystal displays.

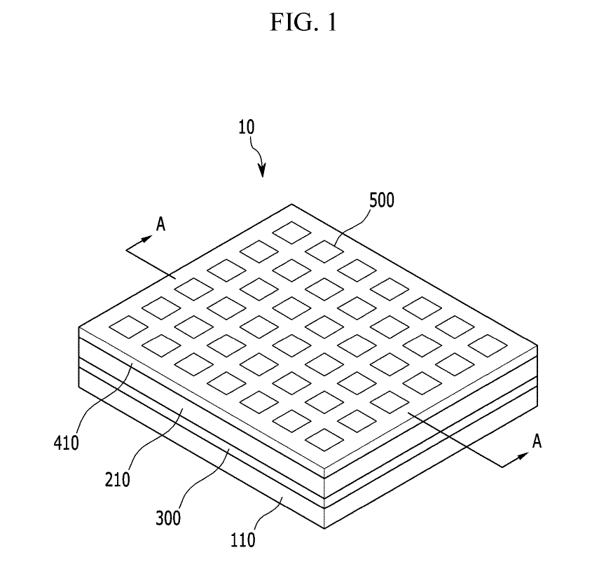

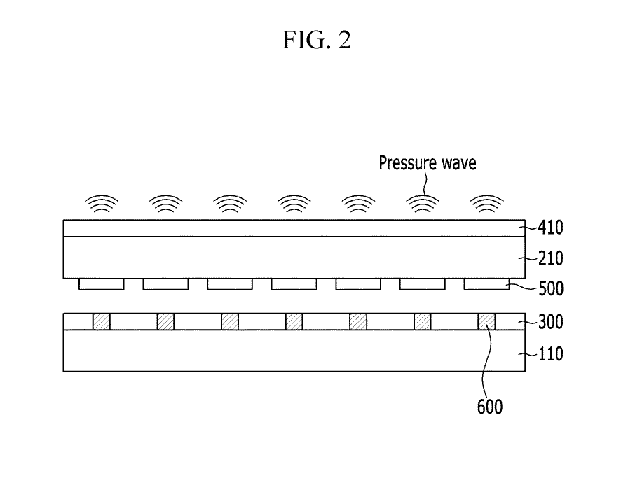

First, a display device according to an exemplary embodiment will be described with reference to FIGS. 1 and 2. Specifically, FIG. 1 illustrates a display device according to the exemplary embodiment, and FIG. 2 illustrates a cross-sectional view of the display device of FIG. 1 taken along line A-A.

Referring to FIG. 1, the display device includes a display panel 10 including a lower substrate 110 and an upper substrate 210 facing each other, and an electro-optical active layer 300 provided therebetween. The lower substrate 110 and the upper substrate 210 are attached together and sealed at their edges by a seal (not shown). The electro-optical active layer 300 includes a pixel area for emitting light for displaying an image, and a non-pixel area which is peripheral to the pixel area. The light coming out of the pixel area may pass through the upper substrate 210 and display an image, as observed by a viewer positioned in front of the display panel 10. In one embodiment, the display panel 10 may be an organic light emitting panel, and the electro-optical active layer 300 may include an organic emission layer formed on the lower substrate 110. In another embodiment, the display panel 10 may be a liquid crystal panel, and the electro-optical active layer 300 may include a liquid crystal layer disposed between the lower substrate 110 and the upper substrate 210. The display panel 10 may include various elements (such as an electrode or a switching element) for applying an electric field to the electro-optical active layer 300. The switching element may be, for example, a thin film transistor formed on the lower substrate 110.

As shown in FIG. 1, the display panel 10 further includes a polarizer film 410 provided on the upper substrate 210. In one embodiment, the display panel 10 may be an organic light emitting panel, and the polarizer film 410 may be a reflection preventing layer that is attached near an edge where the organic light emitting panel meets an external environment, so as to reduce external light reflection. The polarizer film 410 in the organic light emitting panel typically includes a linear polarizer and a circular polarizer including a ¼λ retarder. In another embodiment, the display panel 10 may be a liquid crystal panel, and the polarizer film 410 may transmit light vibrating in one direction and further include a polarizer film (not shown) below the lower substrate 110.

As shown in FIG. 1, the display panel 10 includes a membrane 500. The membrane 500 is included as a layer in the display panel 10. A plurality of membranes 500 may be disposed substantially throughout an entire surface of the display panel 10, and may be disposed in a matrix form. Each membrane 500 may be rectangular and a length of a side thereof may range from about 4 mm to about 5 mm. However, it should be noted that the shape and/or size of the membrane 500 is not limited thereto, and that the membrane 500 may be formed in various shapes and/or sizes in other embodiments.

The membrane 500 is a vibration layer capable of absorbing light of a specific wavelength and vibrating to generate ultrasonic waves. For example, the membrane 500 may absorb light in a non-visible light region (e.g., light in the infrared or near infrared region) and then vibrate to generate ultrasonic waves. In other words, the membrane 500 need not be electrically driven and therefore, the membrane 500 may be independently disposed in the display panel 10 without being connected to any electrical wires. The membrane 500 may be transparent and allow visible light to pass through, so that light coming out of the electro-optical active layer 300 of the display panel 10 for displaying an image is not absorbed by the membrane 500.

In some embodiments, an acoustic lens (not shown) may be used in conjunction with the membrane 500 to focus the ultrasonic waves generated by the vibration of the membrane 500. In some embodiments, the haptic efficiency may be increased through an index matching layer (not shown).

The display device may include a touch sensor (not shown) for sensing a user's direct (contact) or indirect (non-contact) touch on the display panel 10, a touch on a virtual object in a three-dimensional (3D) space, and/or a gesture. For example, the touch sensor may be a motion sensor for capturing an image of an object (using, for example, a camera) and generating data. The generated data may be processed by a touch controller (not shown) of the display device and used to generate touch information for detecting movement and location of the object. The motion sensor can be used to sense a touch (for example, a spatial touch or a 3D touch) on a virtual object in the 3D space. The touch sensor may be based on various sensing mechanisms (such as capacitive, electro-magnetic, and/or optical). In some embodiments, the display device may include a plurality of electrode cells on the display panel 10, and a touch sensor for generating a signal for sensing a touching state and a touch location based on a change of capacitance of the electrode cell induced by a touch.

Referring to FIG. 2, the membrane 500 may be provided inside the upper substrate 210. However, the location of the membrane 500 is not limited thereto. For example, in some embodiments, the membrane 500 may be provided outside the upper substrate 210, or outside (or inside) the lower substrate 110. The inside of a substrate or a layer (as used in this specification) denotes a side that faces the electro-optical active layer, and the outside of the substrate or the layer denotes another side that faces an opposite side of the electro-optical active layer.

The membrane 500 may be formed on the upper substrate 210 or the lower substrate 110. In some embodiments, the membrane 500 may be formed on an additional substrate or a layer that is then attached to the upper substrate 210 or the lower substrate 110. The membrane 500 may also be formed on the polarizer film 410. The membrane 500 may be formed using various methods such as photolithography, inkjet, or screen printing.

The membrane 500 absorbs light of a specific wavelength and then vibrates to generate ultrasonic waves. Accordingly, the display device includes a light source 600 for outputting the light of the specific wavelength. The light source 600 may be an infrared light emitting diode (LED) or an infrared organic light emitting diode (OLED). The light source 600 may be configured to output and direct the light of the specific wavelength towards the membrane 500. The light source 600 is combined with the membrane 500 to form a haptic actuator. It should be noted that the light source 600 may be different from a backlight light source of a liquid crystal display or an organic light emitting diode, whereby the backlight light source is used for displaying an image of the liquid crystal device or the organic light emitting device.

As shown in FIG. 2, the light source 600 may be provided inside the display panel 10. In one embodiment, the display panel 10 may be an organic light emitting panel, the light source 600 may be provided in the electro-optical active layer 300, and the electro-optical active layer 300 may include an organic emission layer. For example, the light source 600 may be provided in a non-emitting region of the electro-optical active layer 300, that is, a region (non-pixel area) in which the organic light emitting diode (for outputting visible light for displaying images) is not disposed. In some embodiments, the light source 600 may be provided in the pixel area in place of some of organic light emitting diodes for outputting visible light in the pixel area. For example, the light source 600 may be an infrared organic light emitting diode. When the light source 600 is disposed inside the display panel 10 (specifically in the electro-optical active layer 300 as described above), a thickness of the display panel 10 need not increase since the light source 600 is embedded within the electro-optical active layer 300. In some alternative embodiments, the light source 600 may be externally provided outside the display panel 10, as described later in the specification.

The light source 600 may be disposed in a one-to-one correspondence with the membrane 500. For example, the light source 600 may be disposed overlapping the membrane 500 in a matrix form. However, it should be noted that the number of light sources 600 need not be equal to the number of membranes 500. For example, in some embodiments, one or more light source 500 may be disposed corresponding to a plurality of membranes 500. In other embodiments, a plurality of light sources 500 may be disposed corresponding to one or more membranes 500.

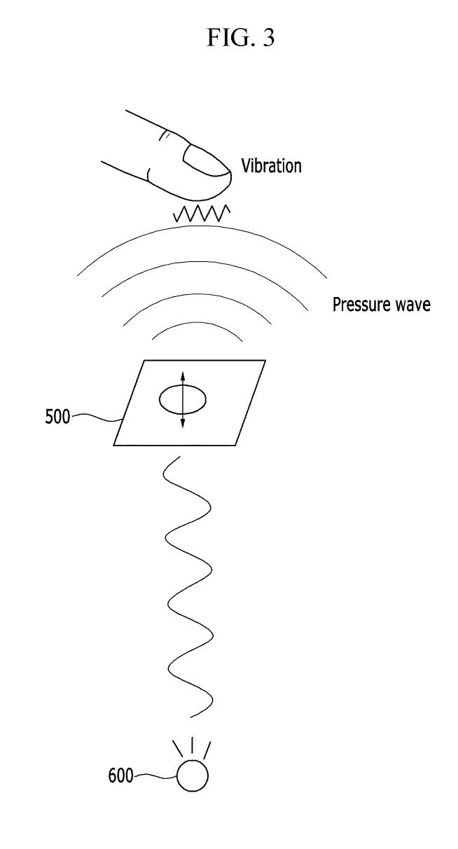

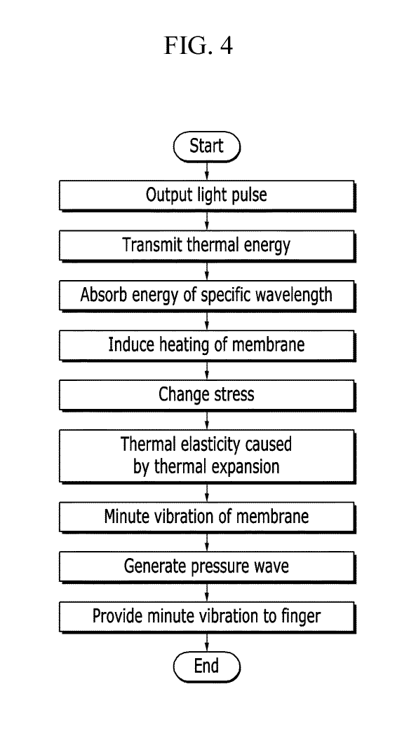

Next, the operation of a haptic actuator inside a display device according to an exemplary embodiment will be described with reference to FIGS. 3 and 4. Specifically, FIG. 3 illustrates a portion of the haptic actuator in the display device according to the exemplary embodiment, and FIG. 4 is a flowchart of an exemplary method of operating the haptic actuator.

The haptic actuator includes a membrane 500 and a light source 600. When the light source 600 outputs a light pulse of the non-visible light region, the light pulse is transmitted as thermal energy to the membrane 500. The membrane 500 absorbs light energy of a specific wavelength, which then causes the membrane 500 to heat up and its stress to change. As a result, the membrane 500 vibrates in minute amounts through thermal elasticity caused by thermal expansion. When the membrane 500 vibrates in minute amounts, ultrasonic waves (which are pressure waves beyond the audible frequency range) are generated, and a sense of touch is provided to the user's finger according to a pressure of the ultrasonic waves. In other words, the membrane 500 absorbs energy from light of a specific wavelength output by the light source 600 and vibrates to generate the ultrasonic waves, and the ultrasonic waves subsequently provide a minute vibration to the user's finger to deliver a sense of touch to the user. The ultrasonic waves are transmitted through a medium (such as air), such that the user may feel the sense of touch (provided by the minute vibration of the ultrasonic waves) even when the user is not directly touching the display panel.

The amplitude of the ultrasonic waves generated by the membrane 500 is proportional to an output of the light source. Therefore, the intensity of the ultrasonic waves may be controlled by controlling the output of the light source. A vibration frequency of the membrane 500 corresponds to a frequency of the light pulse and also corresponds to the frequency of the ultrasonic waves. Hence, the amplitude and the frequency of the ultrasonic waves may be controlled by controlling the amplitude and the frequency of the light pulse. Accordingly, a sense of touch having various frequency and amplitude ranges can be provided, thereby improving haptic performance/feedback.

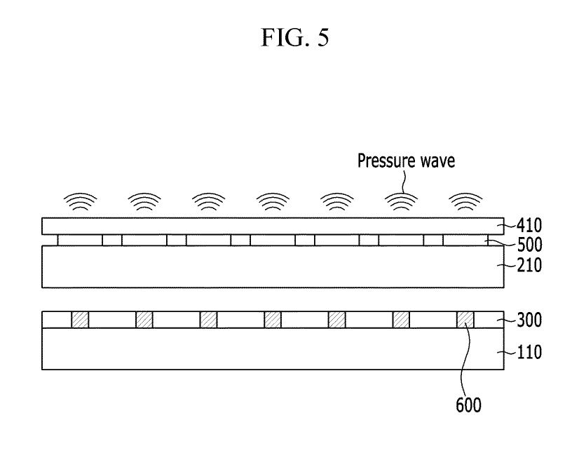

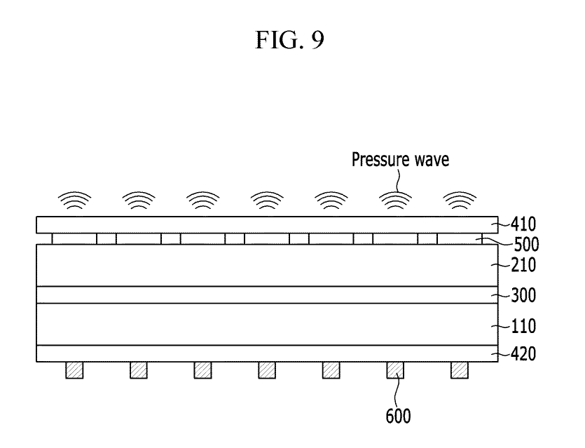

The haptic actuator including the membrane and the light source may be disposed in various locations in the display device, as described in the embodiments in FIGS. 5, 6, 7, 8, and 9. Specifically, FIGS. 5 through 9 illustrate cross-sectional views of a display device according to different exemplary embodiments, whereby the haptic actuator including the membrane and the light source are disposed in different locations. In particular, FIGS. 5 through 8 illustrate a cross-sectional view of an organic light emitting device according to the different exemplary embodiments, and FIG. 9 illustrates a cross-sectional view of a liquid crystal display according to an exemplary embodiment.

The location of the membrane 500 in FIG. 5 is different from that in FIG. 2. In the embodiment of FIG. 5, the membrane 500 is provided outside the upper substrate 210, specifically, between the upper substrate 210 and the polarizer film 410. The membrane 500 may be directly formed outside the upper substrate 210, and may be formed on the polarizer film 410 and attached outside the upper substrate 210.

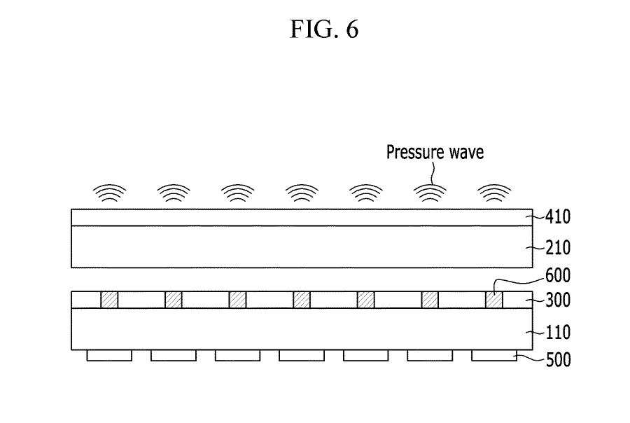

The location of the membrane 500 in FIG. 6 is also different from that in FIG. 2. In the embodiment of FIG. 6, the membrane 500 is provided outside the lower substrate 110. When the membrane 500 is formed on the lower substrate 110, the ultrasonic waves generated by vibration of the membrane 500 may be transmitted through the display panel 10 and provided to a front side so as to provide a haptic feedback. The membrane 500 may be directly formed outside the lower substrate 110. In some embodiments, the membrane 500 may be formed on an additional substrate or a layer (not shown) and attached outside the lower substrate 110.

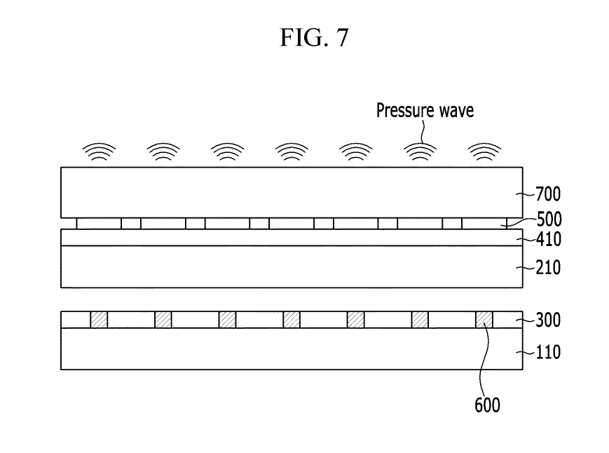

FIG. 7 illustrates an embodiment in which a window 700 is provided on the polarizer film 410. The window 700 may be a glass substrate that is attachable to the display panel 10 to protect the display device in a mobile device. The membrane 500 may be provided between the window 700 and the polarizer film 410. In the embodiment of FIG. 7, the membrane 500 may be directly formed inside the window 700, or directly formed outside the polarizer film 410.

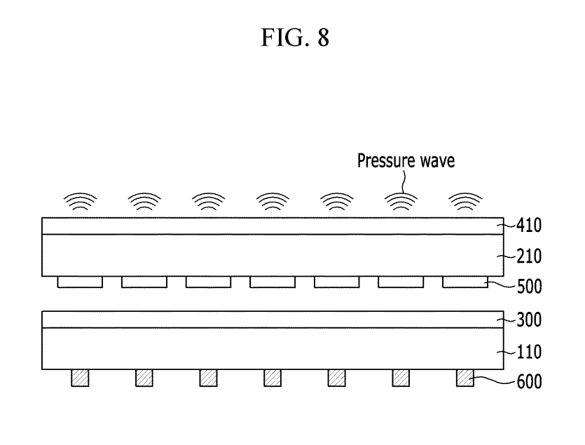

The location of the light source 600 in FIG. 8 is different from that in FIG. 2. In the embodiment of FIG. 8, the light source 600 is not provided inside the display panel 10, for example, in the electro-optical active layer 300. Instead, the light source 600 is provided below the lower substrate 110. The light source 600 may be disposed on an additional substrate (not shown), and provided near or in contact with the lower substrate 110. When the light source 600 is provided outside the display panel 10, the light source 600 may be a light emitting diode, for example, an infrared light emitting diode. In FIG. 8, the membrane 500 is illustrated to be provided inside the upper substrate 210 and the light source 600 is provided below the lower substrate 110. However, such a location of the light source 600 (i.e., below the lower substrate 110) may be applicable to a case in which the membrane 500 is provided outside the upper substrate 210 or inside the window 700, or a case in which it is provided inside or outside the lower substrate, in a like manner of the exemplary embodiments of FIG. 6 and FIG. 7.

In the embodiment of FIG. 9, a liquid crystal layer is provided as an electro-optical active layer 300 between the lower substrate 110 and the upper substrate 210. Polarizer films 410 and 420 are attached over the upper substrate 210 and below the lower substrate 110. In the liquid crystal panel of FIG. 9, the membrane 500 may be provided outside the upper substrate 210, that is, between the upper substrate 210 and the polarizer film 410. In some embodiments (not shown), the membrane 500 may be provided between the lower substrate 110 and the polarizer film 420, inside the upper substrate 210 or the lower substrate 110, or outside the polarizer films 410 and 420.

The light source 600 is provided below the polarizer film 420. The light source 600 may be disposed on an additional substrate (not shown), and provided near or in contact with the polarizer film 420. The light source 600 may be a light emitting diode such as an infrared light emitting diode. When a backlight light source of the liquid crystal display is of a direct-type backlight configuration and provided below the display panel 10, the light source 600 may be provided on a substrate on which the backlight light source of the liquid crystal display is provided.

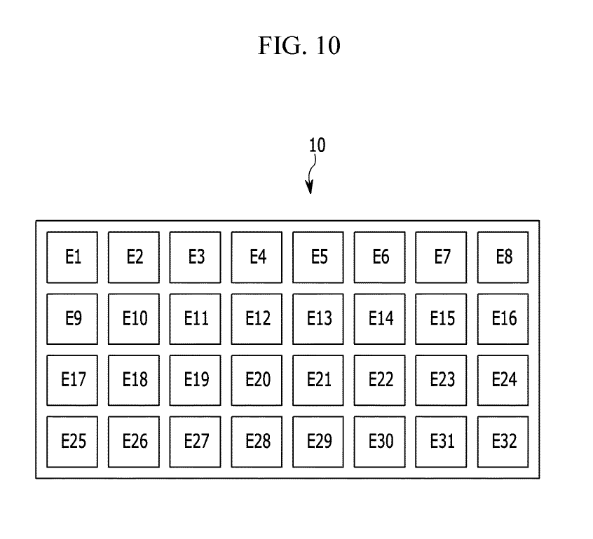

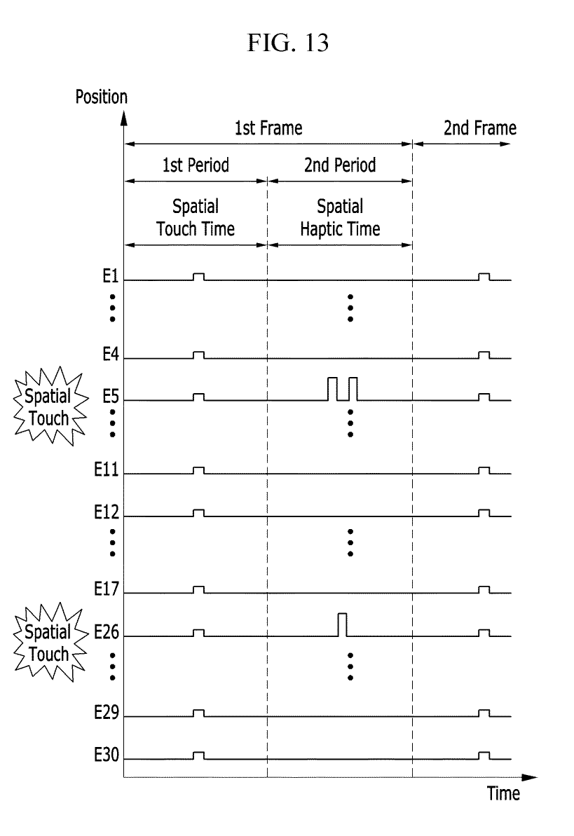

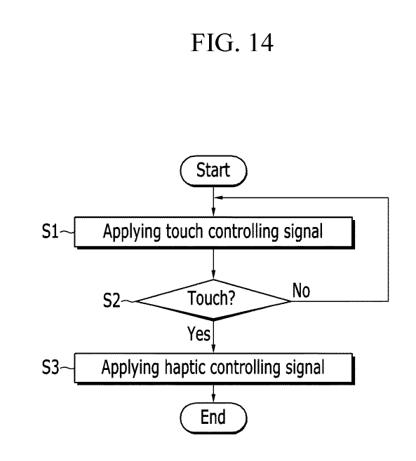

Next, a haptic feedback process and a haptic driving algorithm in a display device according to an exemplary embodiment will be described with reference to FIGS. 10 through 14. Specifically, FIGS. 10, 11, and 12 illustrate a haptic feedback process in a display device according to an exemplary embodiment; FIG. 13 illustrates a timing diagram of a touch input and a haptic feedback according to an exemplary embodiment; and FIG. 14 is a flowchart of a haptic driving algorithm according to an exemplary embodiment.

Referring to FIG. 10 and FIGS. 1 and 2, the membrane 500 is provided in a matrix form throughout a surface of the display panel 10. The membranes have reference numbers E1 to E32. In the embodiment of FIG. 10, a 3D image may be displayed in the display panel 10 having the illustrated membrane arrangement

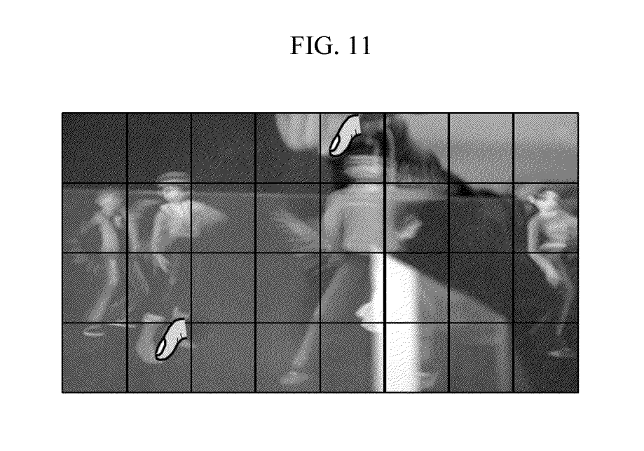

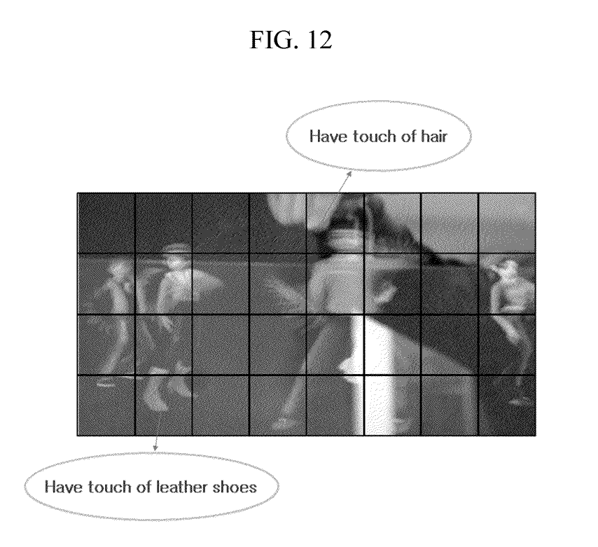

Referring to FIGS. 11 and 12, when a user touches (using a finger) the space corresponding to the membrane E5 or the membrane E26 for the displayed 3D image, the display device senses the spatial touch through a motion sensor, drives the light source 600 corresponding to the membrane E5 or the membrane E26, and generates a light pulse. As a result, the membrane E5 or the membrane E26 vibrates to generate ultrasonic waves which provide a sense of touch to the user (through the user's finger). In some embodiments, the membrane E5 and the membrane E26 may generate different ultrasonic waves. For example, the membrane E5 may generate ultrasonic waves to allow the user to feel as though the user is touching hair, and the membrane E26 may generate ultrasonic waves to allow the user to feel as though the user is touching a leather shoe. Accordingly, various kinds of touch senses may be realized by controlling the amplitude and the frequency of the light pulse generated by the light source 600.

Referring to FIGS. 13 and 14, a signal controller (not shown) of the display device divides a frame temporally to generate a first signal for controlling the touch sensor for a first period and a second signal for controlling the haptic actuator for a second period. The control signal for the touch sensor may be applied to a touch controller (not shown) for the first period (S1), and the signal controller may determine a touch state based on an output signal of the touch sensor before the second period begins (S2) after the control signal is applied in the first period. When the signal controller determines there was a touch, the control signal of the haptic actuator is applied to a haptic controller (not shown) for the second period (S2). Accordingly, the above-described operation may be repeated for each frame.

The control signal of the touch sensor and the control signal of the haptic actuator may be generated for the respective membranes (E1 to E30). Referring to FIGS. 10, 11, and 12, the control signal generated for the membrane E5 and the control signal generated for the membrane E26 may have different waveforms and/or levels so as to generate different ultrasonic waves to the membrane E5 and the membrane E26 to provide different touch senses.

The spatial touch for an object in 3D space that is displayed on a display device (such as a 3D image display device or a transparent display device) has been described above. It should be noted that the inventive concept can also be applied to direct or indirect touch on a display panel on which 2D images are displayed. Furthermore, the inventive concept can also be used to provide haptic feedback for virtual actions such as gestures or hovering, and may be applied to different areas such as 3D modeling software, video games, or the biotechnology/health industry.

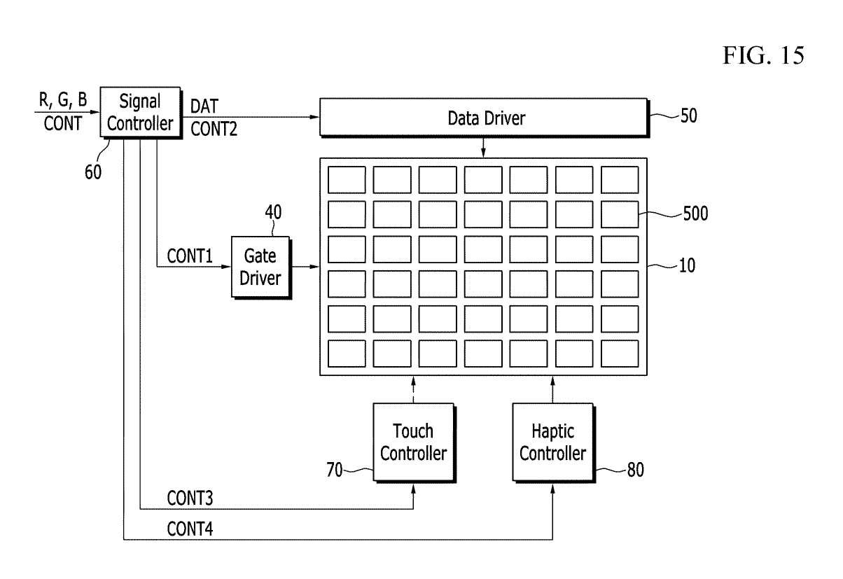

FIG. 15 illustrates a block diagram of a display device according to an exemplary embodiment.

Referring to FIG. 15, the display device includes a gate driver 40 and a data driver 50 connected to a display panel 10, and a signal controller 60 for controlling the gate driver 40, the data driver 50, and the display panel 10. The display device further includes a touch controller 70 for controlling a touch sensor (such as a motion sensor) and a haptic controller 80 for controlling the haptic actuator.

The display panel 10 is configured to display an image. The display panel 10 includes a plurality of gate lines (not shown), a plurality of data lines (not shown), and a plurality of pixels (not shown) connected to the lines through switching elements and arranged in a matrix form. The pixels may include pixels for displaying primary colors such as red, green, and blue. In some embodiments, the pixels may further include a pixel for displaying white color.

The gate driver 40 is connected to a gate line of the display panel 10, and applies a gate-on voltage to the gate line. The data driver 50 is connected to a data line of the display panel 10, and applies a data voltage (corresponding to the input image signals R, G, and B) to the data line. The data driver 50 uses a gray voltage generated by a gray voltage generator (not shown) to convert image data (DAT) into a data voltage. The data voltage is applied to a pixel through a switching element that is turned on by the gate-on voltage, and the pixel displays a luminance based on a difference between the data voltage and a common voltage (reference voltage). The touch controller 70 may include a driving voltage input section for applying a driving voltage to a touch sensor provided on the display panel 10, and a touch signal processor for receiving an output signal of the touch signal and processing the same. The touch signal processor processes the output signal and generates touch information such as a touch state and a touch location. It should be noted that the touch sensor need not be provided on the display panel 10, as previously described.

The haptic controller 80 may apply a driving voltage to the light source 600. The light source 600 may be provided in or near the display panel 10. When the driving voltage is applied to the light source 600, the light source 600 generates a light pulse with an amplitude and a frequency following the driving voltage, and the membrane 500 absorbs energy with a specific wavelength after receiving the light pulse and vibrates to generate ultrasonic waves for providing a haptic feedback. The signal controller 60 receives image signals R, G, and B and a control signal CONT, processes the image and control signals according to an operating condition of the display panel 10, and controls the gate driver 40 and the data driver 50. The signal controller 60 also controls the touch controller 70 and the haptic controller 80. For example, the signal controller 60 may generate a gate control signal CONT1 and a data control signal CONT2 and output the control signals CONT1 and CONT2, and generate a touch control signal CONT3 and a haptic control signal CONT4 and output the control signals CONT3 and CONT4.

The driving devices 40, 50, 60, 70, and 80 may be individually provided or combined with each other. The driving devices may also be provided as an IC chip on the display panel 10. In some embodiments, the driving devices may be provided on a flexible printed circuit film (not shown) and attached as a tape carrier package (TCP) to the display panel 10. In other embodiments, the driving devices may be provided on another printed circuit board (PCB) (not shown). In some further embodiments, the driving devices may be integrated on the display panel 10. While the inventive concept has been described in connection with what is presently known to be exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A display device comprising:
a lower substrate;
an upper substrate facing the lower substrate;
an electro-optical active layer disposed between the lower substrate and the upper substrate; and
a plurality of membranes arranged on a surface of one of the lower substrate and the upper substrate, wherein the plurality of membranes are configured to absorb light of a specific wavelength and vibrate so as to generate ultrasonic waves.

2. The display device of claim 1, further comprising at least one light source for irradiating the light of the specific wavelength.

3. The display device of claim 2, wherein the plurality of membranes are disposed between the upper substrate and the electro-optical active layer.

4. The display device of claim 2, further comprising:
a polarizer film disposed on the upper substrate, wherein the plurality of membranes are disposed between the upper substrate and the polarizer film.

5. The display device of claim 2, wherein the plurality of membranes are disposed outside the lower substrate.

6. The display device of claim 2, further comprising:
a polarizer film disposed on the upper substrate and a window disposed on the polarizer film, wherein the plurality of membranes are disposed between the polarizer film and the window.

7. The display device of claim 2, wherein the light source is disposed in the electro-optical active layer.

8. The display device of claim 7, wherein the light source is disposed in a non-emitting region of the electro-optical active layer.

9. The display device of claim 7, wherein the light source is disposed in a pixel area of the electro-optical active layer.

10. The display device of claim 7, wherein the light source is an infrared organic light emitting diode.

11. The display device of claim 2, wherein the light source is disposed under the lower substrate.

12. The display device of claim 11, wherein the light source is an infrared light emitting diode.

13. The display device of claim 2, wherein the light of the specific wavelength includes light in a near infrared ray region, wherein the plurality of membranes vibrate upon absorbing the light in the near infrared ray region, and wherein the plurality of membranes are transparent to light in a visible region.

14. The display device of claim 2, further comprising a touch sensor configured to generate a signal for sensing a user's touch.

15. The display device of claim 14, wherein the touch sensor includes a motion sensor for sensing a spatial touch.

16. The display device of claim 14, further comprising:
a touch controller configured to apply a driving voltage to the touch sensor and generate an output signal based on touch information;
a haptic controller configured to apply a driving voltage to the haptic actuator; and
a signal controller configured to apply a touch control signal to the touch controller, and apply a haptic control signal to the haptic controller based on an output signal of the touch controller.
